(19) United States
(12) Patent Application Publication
(10) Pub. No.: US 2014/0205261 A1
(43) Pub. Date: Jul. 24, 2014

(54) INTERACTIVE AUDIO/VIDEO SYSTEM AND METHOD

(71) Applicant: Michel Courtemanche, Laval (CA)

(72) Inventor: Michel Courtemanche, Laval (CA)

(21) Appl. No.: 13/746,260

(22) Filed: Jan. 21, 2013

(51) Int. Cl. H04N 9/79

(52) U.S. Cl. CPC H04N 9/79
USPC 386/224

(57) ABSTRACT

There is provided an interactive audio/video system for making an interactive audio/video clip of one or more participant each provided with a green neck and torso bib and a microphone. One or more audio/video camera is aimed at the at least one participant in front of a green screen. An audio/video server in communication with the microphone and video camera is configured to isolate the heads of each of the participants using a Chroma keying process and superimposes them on the body of associated characters in a selected audio/video clip. The voices of the participants are also superimposed on the selected audio/video clip.

### CROSS-REFERENCE TO RELATED APPLICATIONS

This application claims the benefits of U.S. provisional patent application No. 61/632,213 filed on Jan. 20, 2012, which is herein incorporated by reference.

### TECHNICAL FIELD

The present disclosure relates to an interactive audio/video system and method. In one particular embodiment, the present disclosure relates to an interactive karaoke audio/video system and method.

### BACKGROUND

Karaoke is a popular pastime and there is a need for a system and method for making a realistic audio/video performance that incorporates images and voices of the participants, in real time, within an audio/video clip.

### SUMMARY

The present disclosure provides an interactive audio/video system for making an interactive audio/video clip of at least one participant, comprising:
at least one microphone;
at least one camera;
a display;
a screen of a color compatible with a Chroma keying process;
at least one neck and torso bib of a color compatible with a Chroma keying process;
an audio/video database containing at least one audio/video clip and an associated file containing text associated with the audio/video clip; and
a audio/video server in communication with the at least one microphone, the at least one camera, the display and the audio/video database, the audio/video server being configured to:
   access the at least one audio/video clip and the file associated with the at least one audio/video clip from the audio/video database;
   display the text contained in the file associated with the audio/video clip on the display;
   input a video performance of the at least one participant wearing the at least one neck and torso bib in front of the screen using the at least one camera;
   isolate the head of the at least one participant from the recorded audio/video performance using a Chroma keying process;
   superimpose the isolated head of the at least one participant on the body of an associated character in the audio/video clip;
   input the voice of the at least one participant using the at least one microphone; and
   superimpose the recorded voice of the at least one participant on the audio/video clip resulting in the interactive audio/video clip.

There is further provided an interactive audio/video system for making an interactive audio/video clip as above wherein the file associated with the audio/video clip is a video file that comprises:
a video layer consisting of the text;
an audio track having therein encoded head appearance timing reference information for the associated character;
and wherein the audio/video server is further configured to perform the step of superimposing the isolated head of the at least one participant on the body of the associated character in synchronization with the head appearance timing reference information of the associated character.

There is further also provided an interactive audio/video system for making an interactive audio/video clip as above wherein the file associated with the audio/video clip further comprises:
at least one additional audio track having therein encoded information for the associated character selected from the group consisting of voice enabling timing information, angle of view timing reference information and positioning timing reference information;
and wherein the audio/video server is further configured to perform the steps of:
   superimposing the recorded voice of the at least one participant for the associated character on the audio/video clip in synchronization with the voice timing reference information;
   inputting the video performance of the at least one participant for the associated character using a selected one of the at least one camera in synchronization with the angle of view timing reference information; and
   superimposing the isolated head of the at least one participant on the body of the associated character at a position in synchronization with the positioning timing reference information.

The present disclosure also provides a corresponding method of making an interactive audio/video clip of at least one participant.

### BRIEF DESCRIPTION OF THE FIGURES

Embodiments of the disclosure will be described by way of examples only with reference to the accompanying drawing, in which:

FIG. 1 is a schematic representation of an interactive audio/video system in accordance with an illustrative embodiment of the present disclosure;

FIG. 2 is a schematic representation of an exemplary architecture of the audio/video server of FIG. 1;

FIG. 3 is a schematic representation of interactive audio/video systems in communication with a remote audio/video clip distribution server;

FIG. 4 is a flow diagram of an interactive audio/video process in accordance with an illustrative embodiment of the present disclosure;

FIG. 5 is a flow diagram of an illustrative example of the audio mixing process used by the interactive audio/video process;

FIG. 6 is a flow diagram of an illustrative example of the video mixing process used by the interactive audio/video process; and

FIG. 7 is a flow diagram of an illustrative example of the recording process used by the interactive audio/video process.

Similar references used in different Figures denote similar components.

### DETAILED DESCRIPTION

Generally stated, the non-limitative illustrative embodiments of the present disclosure provide an interactive audio/video system and method for integrating, in real time, the singing and/or acting performance of participants into a selected audio/video clip.

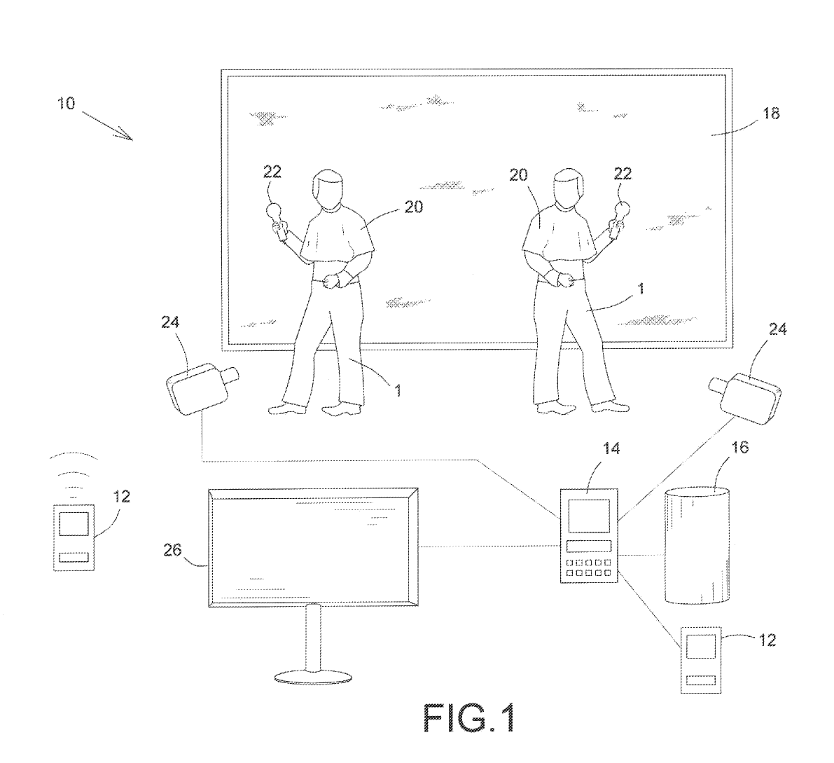

Referring to FIG. 1, the interactive audio/video system 10 generally consists of one or more selection station 12, an audio/video server 14 with an associated audio/video database 16, a green screen 18, one or more green neck and torso bib 20, one or more microphone 22, one or more video camera 24 and a display screen 26.

The one or more selection station 12 is used by participants 1 to select one or more available audio/video clips from the audio/video database 16. Participants 1 may also enter personal information such as name(s), e-mail address(es), etc. The selection station 12 can be a dedicated station with an input/output interface and a communication system to communicate, wirelessly or otherwise, with the audio/video server 14 or a personal computer, lap top computer, tablet device, personal digital assistant, intelligent phone or any other such device. Optionally, the selected audio/video clips may be ghosted in the lists of available audio/video clips for a pre-determined time period in order to avoid a single audio/video clip from being selected repeatedly by multiple participants 1.

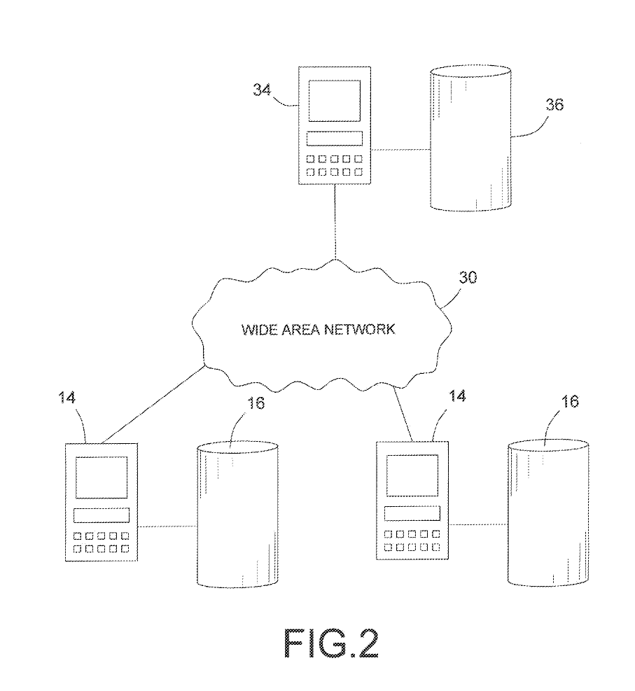

Referring to FIG. 2, the interactive audio/video system 10 may, optionally, further comprise a remote audio/video clip distribution server 34, with an associated remote audio/video clip database 36, accessible from audio/video servers 14 via a wide area network (WAN) 30 such as, for example, Ethernet (broadband, high-speed), wireless WiFi, cable Internet, satellite connection, cellular or satellite network, etc. Audio/video clips with their associated information may be provided by the remote audio/video clip distribution server 34 for remote download to any connected audio/video servers 14 via, for example, an online store application or as part of a subscription agreement.

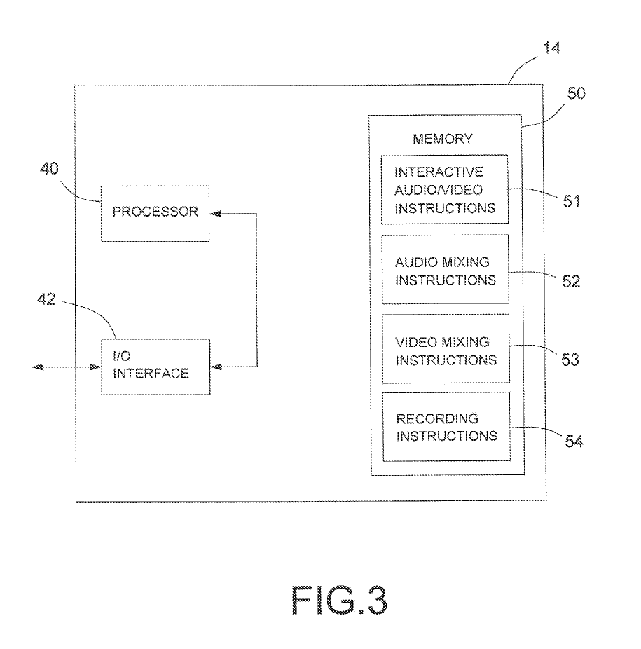

Referring now to FIG. 3, the audio/video server 14 includes a processor 40 with an associated memory 50 having stored therein processor executable instructions for configuring the processor 40 to perform various processes, namely an interactive audio/video process 51, an audio mixing process 52, a video mixing process 53 and a recording process 54, which processes will be further described below. The audio/video server 14 further includes an input/output (I/O) interface 42 for communication with the various components of the interactive audio/video system 10 and, optionally, a remote audio/video clip distribution server 34.

The audio/video server 14 receives participants' 1 selections from the one or more selection station 12 and automatically sorts the selected audio/video clips by the time they were selected. The next audio/video clip in the list along with its associated information is accessed from the audio/video database 16 and the participant 1 having selected the audio/video clip is invited, along with any other associated participants 1, to take position in front of the green screen 18.

The participants 1 are each provided with a green neck and torso bib 20 and a microphone 22, for example a wireless microphone, in communication with the audio/video server 14. The one or more audio/video camera 24 is aimed at the green screen 18 and is in communication with the audio/video server 14 in order to capture images of the participants 1. The heads of each of the participants 1 are isolated from the audio/video feed, for example using a Chroma keying process, and superimposed on the body of an associated character in the selected audio/video clip. The size of the heads may be adjusted in order to properly fit with the body of the associated character. It is to be understood that the heads of the participants 1 may be switched between the various characters if desired.

The selected audio/video clip with the superimposed heads is displayed on the display screen 26 so that the participants 1 may view their live performance as well as the lyrics or dialogue associated with the audio/video clip.

The participants 1 sing along, or recite dialogue, to the audio/video clip's lyrics or dialogue, reading from the display screen 26 while viewing their performance in real time, their voices and image being recorded. In an alternative embodiment, additional display screens may be added in order to display the participants 1 performance to an audience.

### Audio/Video Clips and Associated Information

The audio/video clips in the illustrative embodiment are created by superimposing two video layers: a first layer consisting of a background and a second layer consisting in one or more characters, and one or more audio tracks containing a musical score and/or other background sounds. With each audio/video clip there is also stored in the audio/video database 16 an associated file containing the written lyrics or dialogue, or other text, for the audio/video clip. In the illustrative embodiment the lyrics/dialogue file is a video file comprising a video layer with the lyrics/dialogue and one of more audio tracks used to encode head appearance timing reference information for each character. It is to be understood that in an alternative embodiment the head appearance timing reference information may be omitted. Optionally, further audio tracks may be used to encode voice enabling timing reference information and/or angle of view timing reference information for each character. The voice and head appearance enabling and the angle of view timing reference information may be encoded, for example, by having a signal (e.g. high frequency noise) on an associated audio track above a certain threshold for enablement/selection. In an alternative embodiment, the level of the signal may be indicative of the volume of an associated microphone 22 and the transparency applied to an associated video camera 24. In a further alternative embodiment, different frequencies may be used for associated characters, microphones 22 and video cameras 24.

In another alternative embodiment, the lyrics/dialogue file may also include audio tracks used to encode positioning timing reference information for some or all of the characters appearing in the audio/video clip in order to automatically displace the heads of corresponding participants 1 to follow movements of the characters. This encoded information may be in the form of, for example, Kinect™ data.

It is to be understood that one or more characters may appear in various combinations at various times and that their physical representations may also vary.

In an alternative embodiment, the audio/video clips may be computer generated. In another alternative embodiment the audio/video clips may be preprocessed music videos, movie scenes, etc.

In a further alternative embodiment, one or more logo may be added on a third audio/video layer or may be provided as an associated image file.

The audio/video clips and lyrics/dialogue files may be encoded, for example, in the MP4 format. Furthermore, the audio/video clips and lyrics/dialogue video files stored in the audio/video database 16 may be encrypted using, for example, a 128 bit key based on a serial number of the associated audio/video server 14 so as to be used only by that specific audio/video server 14. In an alternative embodiment, the key may be such as to allow use of the audio/video clips and lyrics/dialogue files by a specific set of audio/video servers 14. In a further alternative embodiment, audio/video clips and lyrics/dialogue files stored in the remote audio/video clip database 36 may be encrypted similarly by the associated remote audio/video clip distribution server 34 upon a request for download by an audio/video server 14.

### Synchronization

The interactive audio/video system 10, using the timing reference information provided for each audio/video clip, synchronizes, for each participant 1, the appearance of the participant's 1 head and, optionally, the enablement of the recording of the voice and the selection of the angle of view of each of the participants 1 with the appearance and singing or talking of an associated character in the audio/video clip. Voice effects for each participant's 1 voice may also be added in real time. It is to be understood that each participant 1 may be associated with one or more characters in the audio/video clip and that the specific associations may be changed during the audio/video performance.

The voice enabling timing reference information is used to enable the audio signal from the microphone 22 associated with each participant 1 and the angle of view timing reference information is used to select from which video camera 24 the image of each of the participant's 1 head should be taken from.

This results in a recorded audio/video performance where the participants' 1 heads are superimposed, in the audio/video clip, on the bodies of associated characters and their voices superimposed on the sound track at appropriate moments.

### Distribution

The participants' 1 performance can be recorded so as to be saved on a DVD, USB key or other such memory support medium and provided to the participants 1 at the conclusion of their performance. The participants' 1 performance can also be saved on a flash drive, hard drive, computer memory, etc. The recorded performance can then be provided to the participants 1 via e-mail, file transfer protocol (FTP) or any other such data transfer or data uploading/downloading services. The participants' 1 performance may further be uploaded to social networking or sharing sites such as Facebook™, Youtube™, etc.

In an alternative embodiment, one or more logo (for example of one or more sponsor) may be added to the recorded performance.

The interactive audio/video system 10 may be provided with a secure payment system, which may be implemented on the one more selection station 12, the audio/video server 14, or be a stand-alone system. In an alternative embodiment, payment may also be provided by phone or Internet.

### Interactive Audio/Video Process

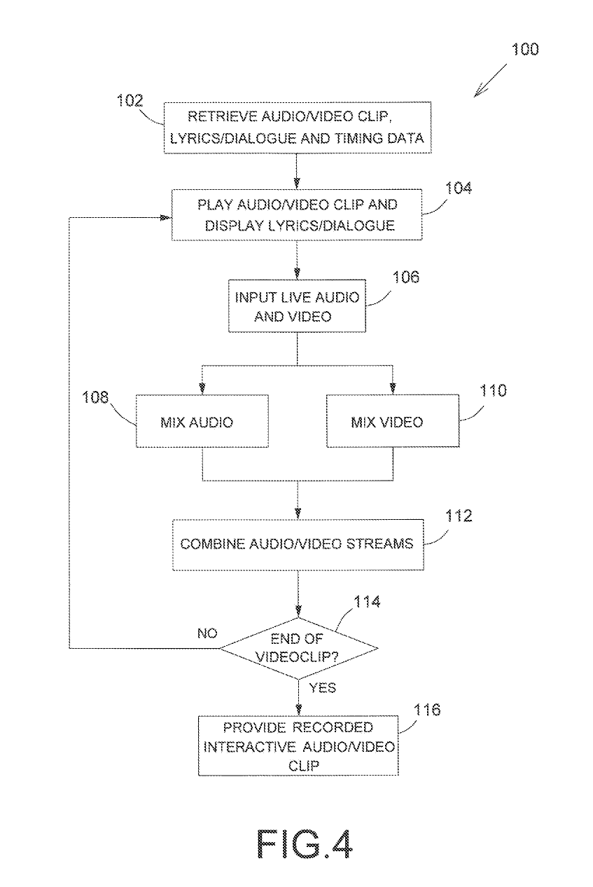

Referring to FIG. 4, there is shown a flow diagram of an illustrative example of the interactive audio/video process 100 executed by the audio/video server 14. Steps of the process 100 are indicated by blocks 102 to 116.

The process 100 starts at block 102 where the selected audio/video clip and associated lyrics/dialogue file containing the timing reference information are accessed from the audio/video database 16.

Then, at block 104, the audio/video clip, with its lyrics or dialogue, are displayed on the display screen 26 and, at block 106, the live performance of the participants 1 is provided to the audio/video server 14 via the one or more microphone 22 and camera 24.

At blocks 108 and 110, the recorded audio and video, respectively, portions of the live performance are mixed in real time with the audio and video of the audio/video clip. The audio and video mixing processes will be further detailed below.

At block 112, the mixed audio and video streams are combined and recorded to produce the interactive audio/video clip. The recording process will be further detailed below.

Then, at block 114, the process 100 verifies if the audio/video clip is at its end, if so it proceeds to 116 where the completed interactive audio/video is provided to the participant(s), if not, it proceeds back to block 104.

### Audio Mixing Process

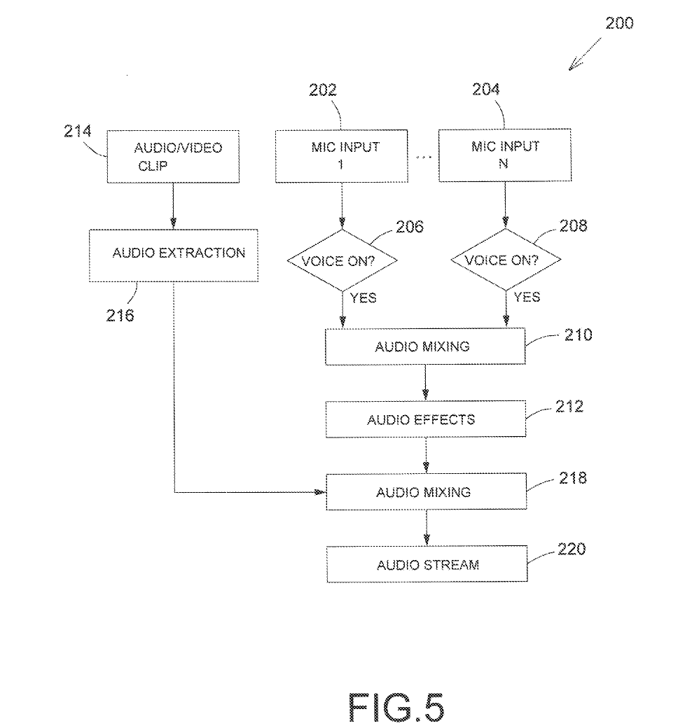

Referring to FIG. 5, there is shown a flow diagram of an illustrative example of the audio mixing process 200 used by the interactive audio/video process 100 of FIG. 4. Steps of the process 200 are indicated by blocks 202 to 220.

The process 200 starts at blocks 202 and 204 where the audio signal from the voice or each participant 1 is inputted from its associated microphone 22. It is to be understood that the number of inputs varies according to the number of microphones 22.

Then, at blocks 206 and 208, the process 200 verifies, for each participant 1, if the voice timing reference information indicates that the character associated with the participant 1 is singing or talking in the audio/video clip. If so, the process 200 enables the associated microphone 22 input and proceeds to block 210, if not, it simply continues monitoring the voice timing reference information until it indicates that the specific microphone 22 input should be enabled.

It is to be understood that if the optional enablement of the recording of the voices is not present then steps 206 and 208 will consequently not be present as well.

At block 210, the voices of the participants 1 whose associated microphone 22 inputs have been enabled are mixed together.

At block 212, audio effects may be added to the voices of the participants 1, for example reverb, echo, etc. These effects may be audio/video clip dependent or operator selectable. It is to be understood that this step may be optional, in which case steps 210 and 212 may be omitted and the mixing effectuated at block 218. It is also to be understood that in an alternative embodiment the audio effects may be added independently to the voice of each participant 1, in which case block 212 will be replaced by corresponding blocks after each individual microphone input 202, 204.

At block 214, the audio/video clip is provided to the audio mixing process 200 following which, at block 216, the audio is extracted from the audio/video clip.

At block 218, the voices of the participants 1 are mixed with the audio of the audio/video clip extracted at block 216.

Finally, at block 212, the mixed audio stream of the participants' 1 performance is provided.

Steps of the audio mixing process 200 may be performed using, for example, Audiolab™ components.

### Video Mixing Process

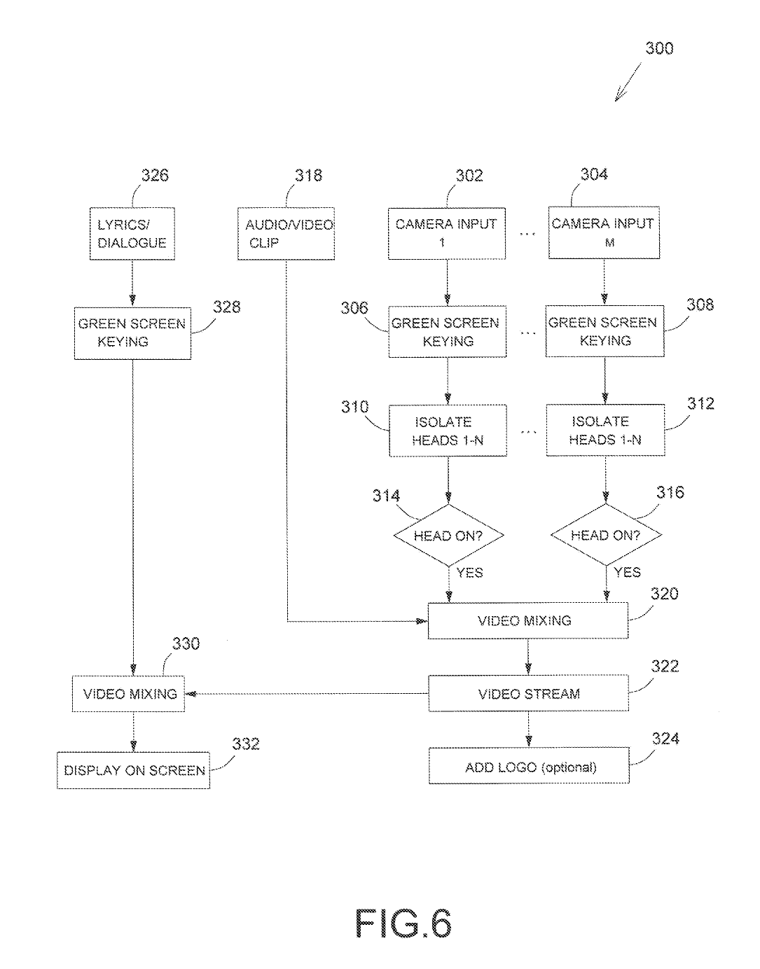

Referring to FIG. 6, there is shown a flow diagram of an illustrative example of the video mixing process 300 used by the interactive audio/video process 100 of FIG. 4. Steps of the process 300 are indicated by blocks 302 to 332.

The process 300 starts at blocks 302 and 304 where the video image of the participants 1 is inputted from the video cameras 24. It is to be understood that the number of inputs varies according to the number of video cameras 24.

At blocks 306 and 308 green screen keying is applied to the video images provided by the video camera 24 inputs of blocks 302 and 304, following which, at blocks 310 and 312, the heads of each of the participants 1 are isolated from the recorded audio/video performance. If multiple video cameras 24 are used, the angle of view timing reference information is used to select from which video camera 24 the image of each of the participant's 1 head should be taken from.

Then, at blocks 314 and 316, the process 300 verifies, for each participant 1, if the head appearance timing reference information indicates that the character associated with the participant 1 is appearing in the audio/video clip. If so, the process 300 enables the video image of the head of the participant 1 and proceeds to block 320, if not, it simply continues monitoring the head appearance timing reference information until it indicates that the head of the specific participant 1 should appear (i.e. its associated character is present in the audio/video clip).

At block 318, the audio/video clip is provided to the video mixing process 300.

At block 320, the images of the heads of the participants 1 whose appearance have been enabled at blocks 314 and 316 are mixed with the audio/video clip provided at block 318 so as to be superimposed on the body of the associated character.

At block 322, the mixed video stream of the participants' 1 performance is provided and, optionally, at block 324, a logo is added to the video stream.

Parallel to the above steps, the lyrics/dialogue file associated with the audio/video clip is provided, at block 326 to the video mixing process 300, following which, at block 328, green screen keying is applied to the video file in order to isolate the lyrics/dialogue.

At block 330, the isolated lyrics/dialogue from block 328 are mixed together with the video stream from block 322 in order to be displayed, at block 332, on the display screen 26 so that the participants 1 may view their live performance as well as the lyrics or dialogue associated with the audio/video clip but not recorded with the live performance.

Steps of the video mixing process 300 may be performed using, for example, MediaLooks™ components.

### Recording Process

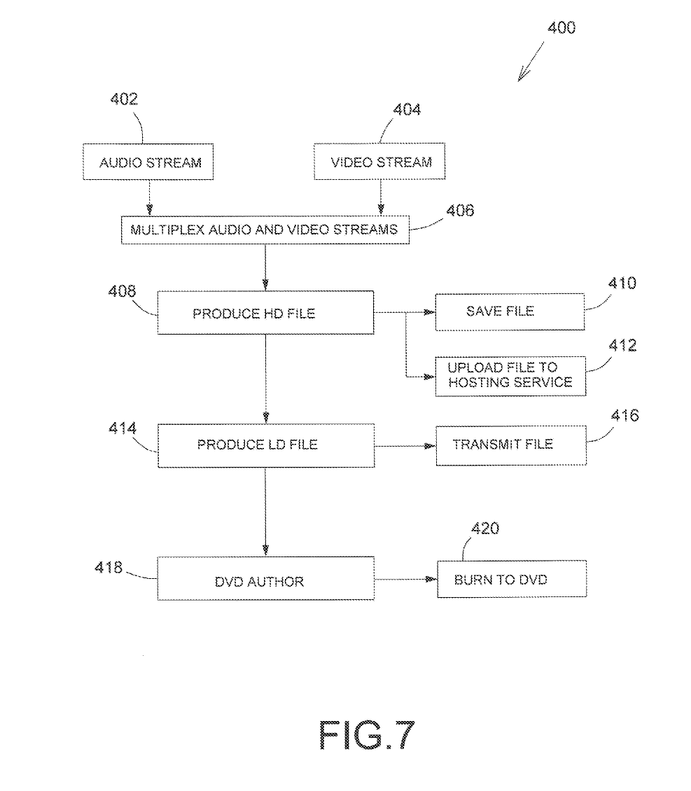

Referring to FIG. 7, there is shown a flow diagram of an illustrative example of the recording process 400 used by the interactive audio/video process 100 of FIG. 4. Steps of the process 400 are indicated by blocks 402 to 420.

The process 400 starts at blocks 402 and 404 where the audio stream from process 200 of FIG. 5 and the video stream from process 300 of FIG. 6 are provided to the recording process 400.

At block 406, the audio and video streams from blocks 402 and 404 are multiplexed together, for example using an advanced streaming format (ASF) multiplexor, to produce, at block 408, a high definition (HD) file of the interactive audio/video clip containing the performance of the participants 1, for example a windows media video (WMV) file.

The HD file of the interactive audio/video clip is then saved, at block 410, for example to a drive, flash memory, etc., and, at block 412, uploaded to a hosting service in order to me remotely accessible via, for example FTP or social networking or sharing sites such as Facebook™, Youtube™, etc.

At block 414, the HD file of the interactive audio/video clip is converted in order to produce a low definition (LD) file of the interactive audio/video clip which, at block 416, can be transmitted to the participants 1 via, for example, e-mail or short message service (SMS) using information initially provided by the participants 1 at one of the selection stations 12.

At block 418, the LD file of the interactive audio/video clip is provided to a DVD author in order to produce, at block 420, a DVD of the interactive audio/video clip containing the performance of the participants 1.

It is to be understood that in alternative embodiments the HD and/or LD files may be saved/transferred to various combinations of memory/storage medium, devices or systems and may also be transmitted using various transmission devices or systems. Consequently, some of blocks 410 to 420 may be modified or omitted.

It is to be understood by a person skilled in the art that the color of the screen 18 and the neck and torso bib 20 may vary depending on the Chroma keying process used and that the disclosed use of the green color is a standard Chroma keying color given as a working example.

Although the present disclosure has been described with a certain degree of particularity and by way of an illustrative embodiments and examples thereof, it is to be understood that the present disclosure is not limited to the features of the embodiments described and illustrated herein, but includes all variations and modifications within the scope and spirit of the disclosure as hereinafter claimed.

What is claimed is:

1. An interactive audio/video system for making an interactive audio/video clip of at least one participant, comprising:
at least one microphone;
at least one camera;
a display;
a screen of a color compatible with a Chroma keying process;
at least one neck and torso bib of a color compatible with a Chroma keying process;
an audio/video database containing at least one audio/video clip and an associated file containing text associated with the audio/video clip; and
a audio/video server in communication with the at least one microphone, the at least one camera, the display and the audio/video database, the audio/video server being configured to:
access the at least one audio/video clip and the file associated with the at least one audio/video clip from the audio/video database;
display the text contained in the file associated with the audio/video clip on the display;
input a video performance of the at least one participant wearing the at least one neck and torso bib in front of the screen using the at least one camera;
isolate the head of the at least one participant from the recorded audio/video performance using a Chroma keying process;
superimpose the isolated head of the at least one participant on the body of an associated character in the audio/video clip;
input the voice of the at least one participant using the at least one microphone; and
superimpose the recorded voice of the at least one participant on the audio/video clip resulting in the interactive audio/video clip.

2. The interactive audio/video system of claim 1, wherein the audio/video server is further configured to:
combine the text contained in the file associated with the audio/video clip and the interactive audio/video clip; and
display the combined text and the interactive audio/video clip on the display.

3. The interactive audio/video system of claims 1, wherein the audio/video server is further configured to:
save the interactive audio/video clip to a storage medium.

4. The interactive audio/video system of claim 1, wherein the audio/video server is further configured to:
apply audio effects to the voice of the at least one participant.

5. The interactive audio/video system of claim 1, further comprising:
at least one selection station in communication with the audio/video server, the at least one selection station being configured so as to select an audio/video clip from the audio/video database.

6. The interactive audio/video system of claim 1, wherein the audio/video clip comprises:
a first video layer consisting of a background;
a second video layer consisting of at least one character; and
an audio track containing a musical score.

7. The interactive audio/video system of claims 1, wherein the file associated with the audio/video clip is a video file that comprises:
a video layer consisting of the text;
an audio track having therein encoded head appearance timing reference information for the associated character;
and wherein the audio/video server is further configured to perform the step of superimposing the isolated head of the at least one participant on the body of the associated character in synchronization with the head appearance timing reference information of the associated character.

8. The interactive audio/video system of claim 7, wherein the file associated with the audio/video clip further comprises:
at least one additional audio track having therein encoded information for the associated character selected from the group consisting of voice enabling timing information, angle of view timing reference information and positioning timing reference information;
and wherein the audio/video server is further configured to perform the steps of:
superimposing the recorded voice of the at least one participant for the associated character on the audio/video clip in synchronization with the voice timing reference information;
inputting the video performance of the at least one participant for the associated character using a selected one of the at least one camera in synchronization with the angle of view timing reference information; and
superimposing the isolated head of the at least one participant on the body of the associated character at a position in synchronization with the positioning timing reference information.

9. The interactive audio/video system of claim 1, further comprising:
a remote audio/video clip distribution server with an associated remote audio/video clip database;
wherein the audio/video clip distribution server is accessible from the audio/video server for downloading additional audio/video clips to the audio/video database.

10. A method of making an interactive audio/video clip of at least one participant, comprising the steps of:
providing an audio/video clip and an associated file containing text associated with the audio/video clip;
displaying the text contained in the file associated with the audio/video clip;
recording a video performance of the at least one participant wearing a neck and torso bib of a color compatible with a Chroma keying process in front of a screen of a color compatible with a Chroma keying process;
isolating the head of the at least one participant from the recorded video performance using a Chroma keying process;
superimposing the isolated head of the at least one participant on the body of an associated character in the audio/video clip;
recording the voice of the at least one participant; and
superimposing the recorded voice of the at least one participant on the audio/video clip resulting in the interactive audio/video clip.

11. The method of making an interactive audio/video clip of claim 1, further comprising the steps of:
combining the text contained in the file associated with the audio/video clip and the interactive audio/video clip; and
displaying the combined text and the interactive audio/video clip.

12. The method of making an interactive audio/video clip of claim 10, further comprising the step of:
saving the interactive audio/video clip to a storage medium.

13. The method of making an interactive audio/video clip of claim 10, further comprising the step of:
applying audio effects to the voice of the at least one participant.

14. The method of making an interactive audio/video clip of claim 10, wherein the file associated with the audio/video clip comprises:
head appearance timing reference information for the associated character;
wherein the step of superimposing the isolated head of the at least one participant on the body of the associated character is performed in synchronization with the head appearance timing reference information of the associated character.

15. The method of making an interactive audio/video clip of claim 14, wherein the file associated with the audio/video clip further comprises:
information for the associated character selected from the group consisting of voice enabling timing information, angle of view timing reference information and positioning timing reference information;
wherein
the step of superimposing the recorded voice of the at least one participant for the associated character on the audio/video clip is performed in synchronization with the voice timing reference information;
the step of recording the video performance of the at least one participant for the associated character is performed using a an angle of view in synchronization with the angle of view timing reference information; and
the step of superimposing the isolated head of the at least one participant on the body of the associated character is performed at a position in synchronization with the positioning timing reference information.
